(19) United States
(12) Patent Application Publication
(10) Pub. No.: US 2005/0149546 A1
(43) Pub. Date: Jul. 7, 2005

(54) Methods and apparatuses for determining and designating classifications of electronic documents

(76) Inventors: Vipul Ved Prakash, San Francisco, CA (US); Mark Stemm, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/979,604

(22) Filed: Nov. 1, 2004

Related U.S. Application Data
(60) Provisional application No. 60/517,010, filed on Nov. 3, 2003.

(51) Int. Cl. G06F 17/00

(52) U.S. Cl. 707/101

(57) ABSTRACT

Embodiments of the invention provide methods and apparatuses for automatically determining and designating classifications of electronic documents. In accordance with one embodiment of the invention, each of a plurality of electronic documents is reduced to a corresponding multidimensional vector based on a multi-dimensional vector space. The distances between multi-dimensional vectors are then evaluated. Multi-dimensional vectors within a specified distance of one another are considered to be a multi-dimensional vector cluster. The multi-dimensional vector space may contain one or more such clusters. Each cluster represents a distinct classification and the electronic documents corresponding to the multi-dimensional vectors of a cluster are classified as such. For one embodiment of the invention features of the electronic documents corresponding to the multi-dimensional vectors of a cluster are used to designate the classification represented by the cluster.

### CLAIM OF PRIORITY

This application is related to, and hereby claims the benefit of provisional application No. 60/517,010, entitled “Unicorn Classifier,” which was filed Nov. 3, 2003 and which is hereby incorporated by reference. This application is related to, and hereby incorporates by reference application number TBD, entitled “Methods and Apparatuses for Classifying Electronic Documents” which was filed on TBD.

### FIELD

Embodiments of the invention relate generally to the field of electronic documents, and more specifically to methods and apparatuses for determining and designating classifications of such documents.

### BACKGROUND

Electronic documents can be classified in many ways. Classification of electronic documents (e.g., electronic communications) may be based upon the contents of the communication, the source of the communication, and whether or not the communication was solicited by the recipient, among other criteria.

One useful way to classify documents is to divide them into collections of similar documents. Each collection contains documents that are similar to each other, and each collection is assigned a classification that succinctly describes the nature of the documents in the collection. Collections can be hierarchical, meaning that documents within a collection may be sub-divided into smaller collections with documents that are more similar to each other than the original set of documents.

Classification can be performed manually by examining each document individually and assigning it into one or more collections. However, this process is time-consuming and prone to error. Alternatively, classification can be performed automatically by analyzing features of individual documents as well as aggregate properties of the collection of documents as a whole. These features and aggregate properties can be used to assign documents to collections and to derive classifications from these collections. This allows a large number of documents to be automatically classified without human intervention.

### BRIEF DESCRIPTION OF THE DRAWINGS

The invention may be best understood by referring to the following description and accompanying drawings that are used to illustrate embodiments of the invention. In the drawings:

FIG. 1 illustrates a process in which electronic communications are reduced to corresponding multi-dimensional vectors based upon a defined multi-dimensional vector space in accordance with one embodiment of the invention;

FIG. 2 illustrates the reduction of an electronic communication to a multi-dimensional vector based upon a defined multi-dimensional vector space in accordance with one embodiment of the invention;

FIG. 3 illustrates a process by which classifications for electronic documents are determined and designated in accordance with one embodiment of the invention;

FIG. 4 illustrates a system for identifying and designating classifications of electronic documents in accordance with one embodiment of the invention; and

FIG. 5 illustrates an embodiment of a digital processing system that may be used in accordance with one embodiment of the invention.

### DETAILED DESCRIPTION

Overview

Embodiments of the invention provide methods and apparatuses for automatically grouping electronic communications into collections of similar documents and assigning classifications to those collections that describe the nature of documents in the collection. In accordance with one embodiment of the invention, each of a plurality of electronic documents is reduced to a corresponding multi-dimensional vector (MDV) based on a multi-dimensional vector space. The distances between multi-dimensional vectors are then evaluated using one of a number of distance metrics. Multi-dimensional vectors within a specified distance of one another are considered to be a multi-dimensional vector cluster. The multi-dimensional vector space may contain one or more such clusters. Each cluster represents a distinct collection and the electronic documents corresponding to the multi-dimensional vectors of a cluster are considered part of that collection. A multi-dimensional vector may be a member of multiple clusters, and as a result its corresponding document may be the member of multiple collections. For one embodiment of the invention, features of the multi-dimensional vectors of a cluster are used to assign classifications to collections. In accordance with one embodiment of the invention, the need for manual evaluation of numerous electronic documents to identify and designate collections is eliminated.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

Process

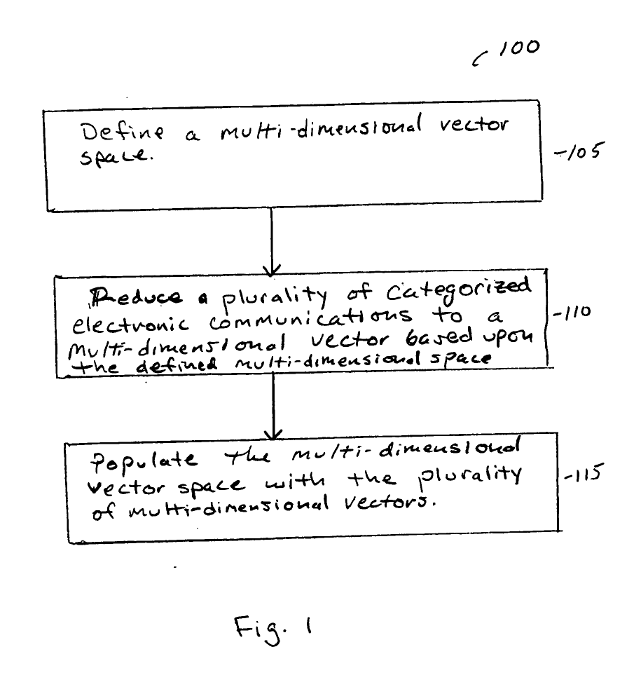

FIG. 1 illustrates a process in which electronic documents are reduced to corresponding MDVs based upon a defined MDV space in accordance with one embodiment of the invention. Process 100, shown in FIG. 1, begins at operation 105 in which an MDV space is defined. The MDV space is defined by a plurality of features. Features may be of various types including words and or phrases contained within the body or header of the electronic documents. Features may also include electronic document genes. Such genes are defined as arbitrary algorithms that take the message as input and return a true/false value as output. Such algorithms can be inserted or modified as necessary and can use external information as additional inputs in determining a return value.

Domains of any hyperlinks found in the electronic documents may also be used as features as can domains present in the electronic document header. Additionally, the result of genes that operate on the header of the electronic document may be features. For one embodiment, the number of features includes approximately 5,000 words and phrases, 500 domain names and host names, and 300 genes.

Features can originate from various sources in accordance with alternative embodiments of the invention. For example, features can originate through initial training runs or user initiated training runs. In accordance with alternative embodiments, feature attributes may be stored for each feature. Such attributes may include a numerical ID that is used in the vector representation, feature type (e.g., ‘word’, ‘phrase’, ‘gene’, ‘domain’), feature source, the feature itself, or the category frequency for each of a number of categories. In accordance with one embodiment, the features may be selected based on their ability to effectively differentiate between communication categories or classifications. This provides features that are better able to differentiate between classifications.

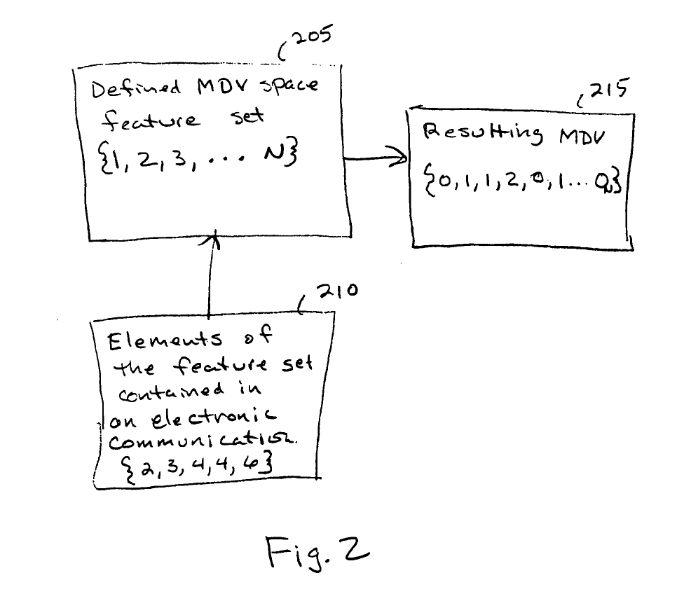

FIG. 2 illustrates the reduction of a single electronic document to an MDV based upon a defined MDV space in accordance with one embodiment of the invention. As shown in FIG. 2, the defined MDV space feature set 205 includes features 1-N. The electronic document that is to be reduced to an MDV contains one occurrence each of features 2, 3, and 6, and two occurrences of feature 4.

The resulting MDV 215 is {0₁, 1₂, 1₃, 2₄, 0₅, 1₆, 0₇, 0₈, . . . 0_{N}}. The resulting MDV reflects which of the features that define the MDV space are present in the corresponding electronic communication, as well as the frequency with which each feature appears in that electronic communication. The resulting MDV has a zero element for each feature that does not appear in the corresponding electronic communication.

For one embodiment of the invention, each feature is weighted depending on the frequency of occurrence of the feature in the one or more electronic documents relative to the frequency of occurrence of each other feature in the at one or more electronic documents (term weight). For one embodiment of the invention, the feature may be weighted depending on the probability of the feature being present in an electronic document of a particular category (category weight). Alternatively, the feature may be weighted using a combination of term weight and category weight. Feature weighting emphasizes features that are rare and that are good category differentiators over features that are relatively common and that occur approximately equally often in all categories.

For one embodiment, the feature weights are used to scale the values of each MDV along their respective dimensions. For example, if a MDV was originally {0₁, 0₂, 1₃, 3₄, 4₅, 0₆, 0₇, 0₈, . . . 0_{N}}, and the feature weights are (1.1₁, 1₂, 3.2₃, 2.5₄, 0.5₅, 0₆, 0₇, 0₈, . . . 0_{N}), then for purposes of determining distance, as described below, the MDV is assumed to be {0₁, 0₂, 3.2₃, 7.5₄, 2₅, 0₆, 0₇, 0₈, . . . 0_{N}},

At operation 110, a training set of electronic documents are reduced to MDVs based upon the defined MDV space. For one embodiment, the electronic documents are electronic communications such as e-mail messages (e-mails). For alternative embodiments the electronic documents may be other types of electronic communications including any type of electronic message including voicemail messages, short messaging system (SMS) messages, multi-media service (MMS) messages, facsimile messages, etc., or combinations thereof. Some embodiments of the invention extend beyond electronic communications to the broader category of electronic documents.

For one embodiment, each of the electronic communications of the training set is assigned into one of a number of categories. For example, each of the electronic communications of the training set may be categorized as spam e-mail or legitimate e-mail for one embodiment. A spam electronic document is herein broadly defined as an electronic document that a receiver does not wish to receive, while a legitimate electronic document is defined as an electronic document that a receiver does wish to receive. Since the distinction between spam electronic documents and legitimate electronic documents is subjective and user-specific, a given electronic document may be a spam electronic document in regard to a particular user or group of users and may be a legitimate electronic document in regard to other users or groups of users.

At operation 115, the MDVs created from the electronic documents are used to populate the defined MDV space.

For one embodiment, the process of reducing a training set of electronic documents to MDVs includes identifying the features that comprise the MDV space and transforming emails into MDVs within that space. For one such embodiment, features are identified by evaluating a set of electronic documents (training set), each of which has been categorized (e.g., categorized as either spam e-mails or legitimate e-mails). The frequency with which each particular feature (e.g., word, phrase, domain, etc.) appears in the training set is then determined. The frequency with which each particular feature appears in each category of electronic communication is also determined. For one embodiment, a table that identifies these frequencies is created. From this information, features that occur often and are also good differentiators (i.e. occur predominantly in a particular category of electronic communication) are determined. For example, commonly occurring features that occur predominantly in spam e-mails (spam word features) or occur predominantly in legitimate e-mails (legit word features) can be determined. Legitimate e-mails are defined, for one embodiment, as non-spam emails. These features are then selected as features of the MDV space. For one embodiment, the MDV space is defined by a set of features including approximately 2,500 spam word features and 2,500 legit word features. For one such embodiment, the MDV space is defined, additionally, by one feature for every gene. Each electronic document of the training set is then reduced to an MDV in the defined MDV space by counting the frequency of the word features in the document and applying each gene to the document. The resulting MDV is then added to the vector space.

The resulting MDV is stored as a sparse matrix (i.e., most of the elements are zero). As will be apparent to those skilled in the art, although described as multi-dimensional, each MDV may contain as few as one non-zero element.

Distance Metrics

The similarity of two documents is proportional to the distance between their corresponding MDVs in the MDV space. Two documents whose MDVs are very close to each other in the MDV space are considered more similar than two documents whose MDVs are farther away from each other. For various alternative embodiments of the invention, any one of several specific distance metrics may be used. For example, a percentage of common dimensions distance metric in which the distance between two MDVs is proportional to the number of non-zero dimensions which the two MDVs have in common; a Manhattan distance metric in which the distance between two MDVs is the sum of the differences of the feature values of each MDV; and a Euclidean distance metric in which the distance between two MDVs is the length of the segment joining two vectors in the MDV space.

For one embodiment of the invention, a cosine similarity distance metric is used. A cosine similarity distance metric computes the similarity between two MDVs based upon the angle (through the origin) between the two MDVs. That is, the smaller the angle between two MDVs, the more similar the two MDVs are.

For one embodiment of the invention, a distance metric based on ratio of weighted frequencies is used. The metric computes for two MDVs the ratio of the sum of the weighted feature frequencies the MDVs have in common and the sum of all weighted feature frequencies for both MDVs.

Classification Determination and Designation

Embodiments of the invention provide a method for determining and designating classifications for electronic documents. Embodiments of the invention rely on the processes of reducing electronic documents to MDV based upon an MDV space and determining the distances between such MDVs within the MDV space to effect such determination and designation. For one embodiment of the invention, the distances between MDVs are calculated, for example, using the methods as described above, and then evaluated. MDVs within a specified distance of one another are considered to be in a cluster. The cluster is determined to represent a corresponding classification, which has a degree of distinctiveness (narrowness) corresponding to the specified distance between the MDVs comprising the corresponding cluster. For one embodiment, the features present in the MDVs that comprise the cluster are used to determine the cluster's corresponding classification. Each of the electronic documents corresponding to one of the MDVs within the cluster is classified using the corresponding classification.

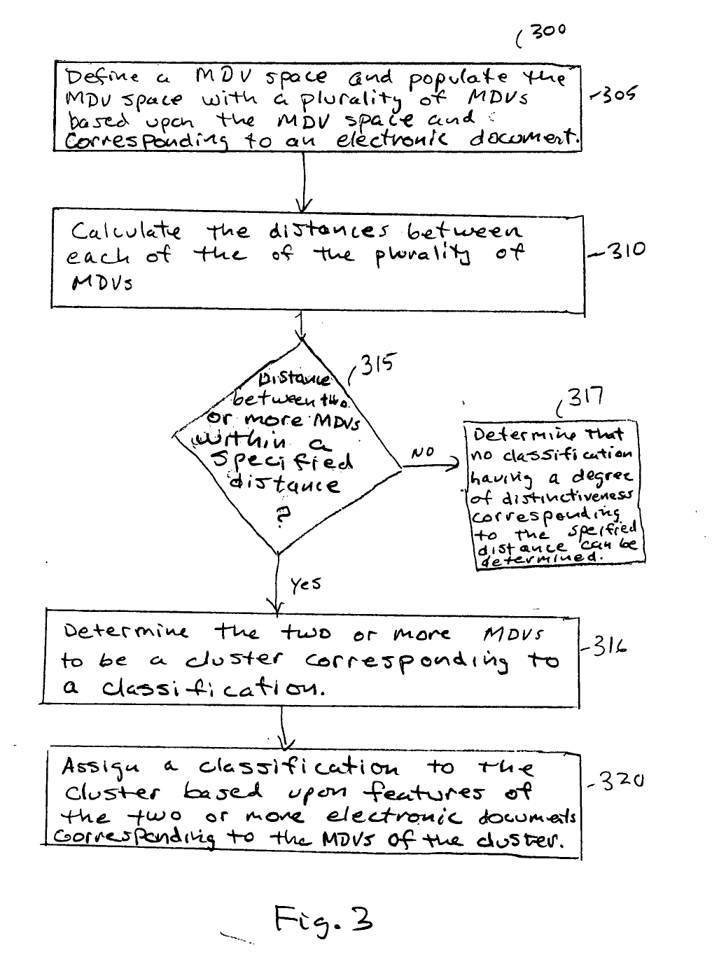

FIG. 3 illustrates a process by which classifications for electronic documents are determined and designated in accordance with one embodiment of the invention. Process 300, shown in FIG. 3, begins at operation 305 in which an MDV space is defined and populated with a plurality of MDVs based upon the MDV space, each of the plurality of MDVs corresponding to an electronic document. For one embodiment of the invention, this operation may be effected, for example, as discussed above in reference to process 100 of FIG. 1.

At operation 310, the distances between each of the plurality of MDVs are calculated.

At operation 315, a determination is made as to whether the distance between two or more of the MDVs is within a specified distance.

If, at operation 315, the distance between two or more of the MDVs is within a specified distance, the two or more of the MDVs are determined to be a cluster corresponding to a classification at operation 316. For one embodiment, a threshold number of MDVs, within the specified distance, may be specified to help ensure that the determined cluster corresponds to a classification of interest.

If, at operation 315, the distance between two or more of the MDVs is not within a specified distance, then it is determined, at operation 317, that no classifications having a degree of distinctiveness corresponding to the specified distance can be determined.

At operation 320, a cluster determined at operation 316, is assigned a classification based upon the features of one or more of the electronic documents corresponding to MDVs comprising the cluster. For one embodiment, the most common features of one or more electronic documents are used to designate the classification. For one embodiment of the invention, all of the features of all of the electronic documents corresponding to MDVs comprising the cluster are evaluated and ranked, with the resulting ranking used as the designation of the classification. For alternative embodiments, the features may be ranked by term weight, category weight, or a combination thereof.

For alternative embodiments, only the most common features are used in the classification designation process. Additionally or alternatively, for various embodiments of the invention, the features of only a portion of the electronic documents corresponding to MDVs comprising the cluster are used in the classification designation process. For example, for one embodiment, the features used for the classification designation process may include only those features from electronic documents for which the corresponding MDVs are most closely clustered (i.e., within a smaller specified distance).

System

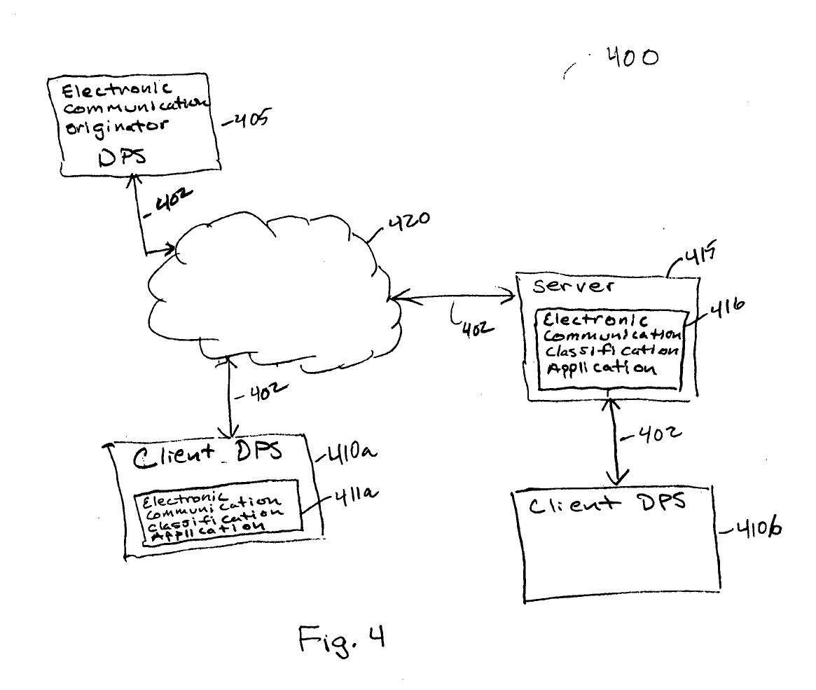

Embodiments of the invention may be implemented in a network environment. FIG. 4 illustrates a system for identifying and designating classifications of electronic documents in accordance with one embodiment of the invention. System 400, shown in FIG. 4, illustrates a network of digital processing systems (DPSs) that may include a DPS 405 that originates and communicates electronic documents, and one or more client DPSs 410a and 410b that receive the electronic documents from DPS 405. System 400 may also include one or more server DPSs, shown as server DPS 415, through which electronic communications may be communicated.

The DPSs of system 400 are coupled one to another and are configured to communicate a plurality of various types of electronic documents or other stored content including documents such as web pages, content stored on web pages, including text, graphics, and audio and video content. For example, the stored content may be audio/video files, such as programs with moving images and sound. Information may be communicated between the DPSs through any type of communications network through which a plurality of different devices may communicate such as, for example, but not limited to, the Internet, a wide area network (WAN) not shown, a local area network (LAN), an intranet, or the like. For example, as shown in FIG. 4, the DPSs are interconnected one to another through Internet 420 which is a network of networks having a method of communicating that is well known to those skilled in the art. The communication links 402 coupling the DPSs need not be a direct link, but may be indirect links including but not limited to, broadcasted wireless signals, network communications or the like. While exemplary DPSs are shown in FIG. 4, it is understood that many such DPS are interconnected.

In accordance with one embodiment of the invention, DPS 410a stores a plurality of electronic documents. These electronic documents may have been originated at DPS 405 and communicated via Internet 420 to DPS 410a. The electronic document classification determination and designation application (EDCDDA) 411a determines classifications for the electronic documents and designates the classifications in accordance with an embodiment of the invention as described above. For example, the EDCDDA may determine a classification regarding purchasing real estate within the general classification of spam e-mails. The EDCDDA may designate such a classification as “buy real estate cheap,” (or simply “real estate spam”), based upon features of the electronic documents within the classification as described above.

For an alternative embodiment, the plurality of electronic documents may be stored on server DPS 415. Again, the electronic documents may have been originated at DPS 405 and communicated via Internet 420 to server DPS 415. The EDCDDA 416 determines classifications for the electronic documents and designates the classifications in accordance with an embodiment of the invention as described above. For one embodiment of the invention, a user at client DPS 410b may then access the classification determination and designation information and decide which classifications of electronic documents are of interest and access those electronic documents. That is, the user requests electronic documents in classifications of interest be communicated from server DPS 415 to client DPS 410b. For example, the EDCDDA 416 may determine two classifications within the general classification of spam e-mails. One of the classifications may be regarding purchasing prescription drugs and may be designated “online prescriptions now,” the other classification may be regarding home equity loans and may be designated “low interest rate refinancing.” The user may choose to receive one of these categories of spam while avoid receiving the other. For an alternative embodiment, all of the electronic documents may be accessible to the user (e.g., may be communicated from the server) along with the classification determination and designation information. The user may then access those classifications of electronic documents that are of interest while discarding or ignoring the others.

General Matters

Embodiments of the invention provide methods and apparatuses for automatically determining and designating classifications for electronic documents, thus eliminating the need for the manual evaluation of numerous electronic documents to identify and designate classifications. In accordance with various alternative embodiments of the invention, general classifications of electronic documents can be sub-classified to provide greater user discretion in addressing such documents. For example, e-mails of the general classification of spam e-mails may be sub-classified into many, descriptively designated classifications allowing a user to decide whether or not to access an electronic communication that would otherwise be discarded as spam.

Legitimate e-mails may be sub-classified as well, in accordance with an embodiment of the invention. For example, legitimate e-mails may be classified as being personal or business-related. The personal classification may be determined and designated by reference to increased slang, affectionate terms, or diminutive name spellings, for example. The business classification may be determined and designated by reference to particular employers or customers, or by use of formal salutations, for example. Each sub-classification may be further sub-classified as often as is practical and beneficial. For example, the classification of business-related e-mails, which may have been designated as “ABC Corp Ms. Jones” can be further sub-classified by, for example, particular projects, clients, or other business-related efforts or terms (e.g., “ABC Corp Ms. Jones Project X, ABC Corp Ms Jones Mr. Smith, etc.).

Moreover, existing electronic documents that have already been classified in accordance with a prior art classification scheme may be reclassified in accordance with one embodiment of the invention. Such an embodiment may be helpful where an existing classification scheme is unable to address dynamic classification requirements or increasing numbers and sizes of electronic documents.

Broadening Classifications

For one embodiment of the invention, broader sub-classifications may be determined and designated. Such broader classifications may consist of a determined sub-classification together with additional electronic documents. For alternative embodiments of the invention, a broader classification may consist of two or more sub-classifications, as well as additional electronic documents.

Broader classifications may be determined by adjusting the specified distance between MDVs as described above in reference to process 300 of FIG. 3. For example, if a cluster and a corresponding classification are determined for a given specific distance, a broader classification may be determined by increasing the specific distance to encompass additional MDVs in the MDVs. The original cluster together with the additionally encompassed MDVs then constitutes a greater-cluster corresponding to a broader classification. The broader classification may then be designated based upon features of the electronic documents corresponding to the MDVs comprising the cluster corresponding to the broader classification.

Broader classifications may also be determined by calculating the distance between a plurality of clusters determined within an MDV space. Operations 315-320 of process 300 of FIG. 3 are then applied to the determined clusters in similar fashion to their application to MDVs. That is, if the distance between a particular cluster and one or more other clusters is within a specified distance, such clusters are determined to constitute a super-cluster and a corresponding broader classification. The broader classification may then be designated based upon features of the electronic documents corresponding to the MDVs comprising the two or more clusters corresponding to the broader classification. Alternatively, the broader classification may be designated by concatenating the designations of the two or more clusters corresponding to the broader classification.

Specified Distance Range

For one embodiment of the invention, the specified distance may be a simple threshold distance, while in other embodiments, the specified distance may be a distance range.

For example, it may be empirically determined that a particular general classification of electronic document tends to result in MDVs that are more closely clustered than MDVs corresponding to electronic documents of a different general classification. For example, it is generally true that MDVs corresponding to spam e-mails cluster more closely than MDVs corresponding to legit e-mails. Therefore, if a user desired to determine sub-classifications within the general classification of legit e-mails using a MDV space populated with MDVs corresponding to both spam emails and legit e-mails, the specified distance, in accordance with one embodiment of the invention, could be specified as a distance range. This would allow the more closely clustered MDVs (probably corresponding to spam e-mails) to be ignored, while still determining clusters from among the more loosely clustered MDVs (probably corresponding to legit e-mails).

The invention includes various operations. Many of the methods are described in their most basic form, but operations can be added to or deleted from any of the methods without departing from the basic scope of the invention. The operations of the invention may be performed by hardware components or may be embodied in machine-executable instructions as described above. Alternatively, the steps may be performed by a combination of hardware and software. The invention may be provided as a computer program product that may include a machine-readable medium having stored thereon instructions, which may be used to program a computer (or other electronic devices) to perform a process according to the invention as described above.

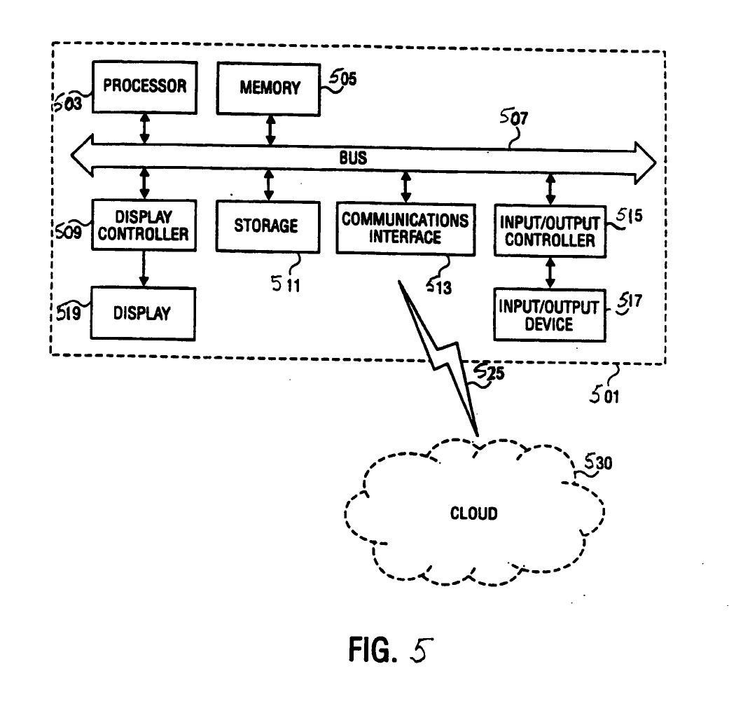

FIG. 5 illustrates an embodiment of a digital processing system that may be used for the DPSs described above in reference to FIG. 4, in accordance with an embodiment of the invention. For alternative embodiments of the present invention, processing system 501 may be a computer or a set top box that includes a processor 503 coupled to a bus 507. In one embodiment, memory 505, storage 511, display controller 509, communications interface 513, and input/output controller 515 are also coupled to bus 507.

Processing system 501 interfaces to external systems through communications interface 513. Communications interface 513 may include an analog modem, Integrated Services Digital Network (ISDN) modem, cable modem, Digital Subscriber Line (DSL) modem, a T-1 line interface, a T-3 line interface, an optical carrier interface (e.g. OC-3), token ring interface, satellite transmission interface, a wireless interface or other interfaces for coupling a device to other devices. Communications interface 513 may also include a radio transceiver or wireless telephone signals, or the like.

For one embodiment of the present invention, communication signal 525 is received/transmitted between communications interface 513 and the cloud 530. In one embodiment of the present invention, a communication signal 525 may be used to interface processing system 501 with another computer system, a network hub, router, or the like. In one embodiment of the present invention, communication signal 525 is considered to be machine readable media, which may be transmitted through wires, cables, optical fibers or through the atmosphere, or the like.

In one embodiment of the present invention, processor 503 may be a conventional microprocessor, such as, for example, but not limited to, an Intel Pentium family microprocessor, a Motorola family microprocessor, or the like. Memory 505 may be a machine-readable medium such as dynamic random access memory (DRAM) and may include static random access memory (SRAM). Display controller 509 controls, in a conventional manner, a display 519, which in one embodiment of the invention may be a cathode ray tube (CRT), a liquid crystal display (LCD), an active matrix display, a television monitor, or the like. The input/output device 517 coupled to input/output controller 515 may be a keyboard, disk drive, printer, scanner and other input and output devices, including a mouse, trackball, trackpad, or the like.

Storage 511 may include machine-readable media such as, for example, but not limited to, a magnetic hard disk, a floppy disk, an optical disk, a smart card or another form of storage for data. In one embodiment of the present invention, storage 511 may include removable media, read-only media, readable/writable media, or the like. Some of the data may be written by a direct memory access process into memory 505 during execution of software in computer system 501. It is appreciated that software may reside in storage 511, memory 505 or may be transmitted or received via modem or communications interface 513. For the purposes of the specification, the term “machine readable medium” shall be taken to include any medium that is capable of storing data, information or encoding a sequence of instructions for execution by processor 503 to cause processor 503 to perform the methodologies of the present invention. The term “machine readable medium” shall be taken to include, but is not limited to, solid-state memories, optical and magnetic disks, carrier wave signals, and the like.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A method comprising:
defining a multi-dimensional vector space;
reducing each of a plurality of electronic documents to a corresponding multi-dimensional vector based upon the defined multi-dimensional vector space;
calculating a distance between each corresponding multi-dimensional vector of one or more portions of the plurality of corresponding multi-dimensional vectors, each portion of the plurality of corresponding multi-dimensional vectors containing a plurality of corresponding multi-dimensional vectors; and
determining one or more classifications for one or more respective portions of the electronic documents based upon the calculated distances, properties of the multi-dimensional vectors, and properties of the defined multi-dimensional vector space.

2. The method of claim 1 where the electronic documents have been initially assigned to one of a number of categories.

3. The method of claim 1 wherein the dimensions of the multi-dimensional vector space are defined by at least one feature.

4. The method of claim 3 wherein each of the at least one feature is selected based upon the differentiation ability of the feature.

5. The method of claim 3 wherein the at least one feature is based upon criteria selected from the group consisting of selected words, selected phrases, algorithms, phone numbers, and URLs.

6. The method of claim 5 where an algorithm returns a description of the structure and text of the electronic document.

7. The method of claim 6 where the algorithm extracts a pattern from the electronic document.

8. The method of claim 7 where the algorithm is a regular expression.

9. The method of claim 3 wherein each of the at least one feature is weighted based upon a differentiation ability of the feature.

10. The method of claim 9 wherein the feature weighting is based upon a rarity of occurrence in the multi-dimensional vector space.

11. The method of claim 9 wherein the feature weighting is based upon an occurrence in particular category and non-occurrence in at least one other category.

12. The method of claim 3 wherein the at least one feature is derived from a corpus of categorized electronic documents.

13. The method of claim 3 wherein the electronic document is reduced to a corresponding multi-dimensional vector based upon an occurrence and frequency of the at least one feature.

14. The method of claim 1 wherein the electronic document is an electronic communication.

15. The method of claim 14 wherein the electronic communication is an e-mail.

16. The method of claim 1 wherein the electronic document is an electronic publication.

17. The method of claim 16 wherein the electronic document is a world wide web page.

18. The method of claim 1 wherein the corresponding multi-dimensional vector indicates an occurrence and a frequency of one or more of the features in the defined vector space.

19. The method of claim 1 wherein determining one or more classifications for one or more respective portions of the electronic documents further comprises:
comparing the calculated distance between each corresponding multi-dimensional vector to a specified distance;
determining if the distance between two or more multi-dimensional vectors is within a specified distance;
determining that two or more multi-dimensional vectors having a distance between them that is within the specified distance constitute a cluster; and
designating a classification for this cluster.

20. The method of claim 19 further comprising:
designating the classification of a cluster based upon the features of the two or more multi-dimensional vectors that constitute the cluster.

21. The method of claim 1 wherein the distance between each corresponding multi-dimensional vector of one or more portions of the plurality of corresponding multi-dimensional vectors is calculated using a specific distance metric.

22. The method of claim 21 wherein the specific distance metric is a cosine similarity distance metric.

23. The method of claim 21 wherein the specific distance metric is a ratio of weighted feature frequencies for the features the two multi-dimensional vectors have in common and weighted feature frequencies for the all features for the two multi-dimensional vectors.

24. The method of claim 21 wherein the specific distance metric is selected from the group of distance metrics consisting of a non-zero dimension proportionality distance metric, a Manhattan distance metric, a Euclidean distance metric, a cosine similarity distance metric, and combinations thereof.

25. The method of claim 19 wherein the specified distance is a distance range.

26. The method of claim 19 further comprising:
specifying a second distance;
comparing the calculated distance between each corresponding multi-dimensional vector to the second distance;
determining if the distance between two or more multi-dimensional vectors is within the second distance;
determining that two or more multi-dimensional vectors having a distance between them that is within the second distance constitute an additional cluster; and
designating a classification to the additional cluster.

27. The method of claim 1 wherein a plurality of classifications has been determined, further comprising:
specifying a second distance;
examining the classifications that result from the calculated distances, properties of the multi-dimensional vectors, and properties of the defined multi-dimensional vector space; and
determining one or more additional classifications for one or more respective portions of the electronic documents based upon the second distance and the classifications that result from the calculated distances, properties of the multi-dimensional vectors, and properties of the defined multi-dimensional vector space.

28. A machine-readable medium having stored thereon a set of instructions which when executed cause a system to perform a method comprising:
defining a multi-dimensional vector space;
reducing each of a plurality of electronic documents to a corresponding multi-dimensional vector based upon the defined multi-dimensional vector space;
calculating a distance between each corresponding multi-dimensional vector of one or more portions of the plurality of corresponding multi-dimensional vectors, each portion of the plurality of corresponding multi-dimensional vectors containing a plurality of corresponding multi-dimensional vectors; and
determining one or more classifications for one or more respective portions of the electronic documents based upon the calculated distances, properties of the multi-dimensional vectors, and properties of the defined multi-dimensional vector space.

29. The machine-readable medium of claim 28 where the electronic documents have been initially assigned to one of a number of categories.

30. The machine-readable medium of claim 28 wherein the dimensions of the multi-dimensional vector space are defined by at least one feature.

31. The machine-readable medium of claim 30 wherein each of the at least one feature is selected based upon the differentiation ability of the feature.

32. The machine-readable medium of claim 30 wherein the at least one feature is based upon criteria selected from the group consisting of selected words, selected phrases, algorithms, phone numbers, and URLs.

33. The machine-readable medium of claim 32 where an algorithm returns a description of the structure and text of the electronic document.

34. The machine-readable medium of claim 33 where the algorithm extracts a pattern from the electronic document.

35. The machine-readable medium of claim 34 where the algorithm is a regular expression.

36. The machine-readable medium of claim 30 wherein each of the at least one feature is weighted based upon a differentiation ability of the feature.

37. The machine-readable medium of claim 36 wherein the feature weighting is based upon a rarity of occurrence in the multi-dimensional vector space.

38. The machine-readable medium of claim 36 wherein the feature weighting is based upon an occurrence in particular category and non-occurrence in at least one other category.

39. The machine-readable medium of claim 30 wherein the at least one feature is derived from a corpus of categorized electronic documents.

40. The machine-readable medium of claim 30 wherein the electronic document is reduced to a corresponding multi-dimensional vector based upon an occurrence and frequency of the at least one feature.

41. The machine-readable medium of claim 28 wherein the electronic document is an electronic communication.

42. The machine-readable medium of claim 41 wherein the electronic communication is an e-mail.

43. The machine-readable medium of claim 28 wherein the electronic document is an electronic publication.

44. The machine-readable medium of claim 43 wherein the electronic document is a world wide web page.

45. The machine-readable medium of claim 28 wherein the corresponding multi-dimensional vector indicates an occurrence and a frequency of one or more of the features in the defined vector space.

46. The machine-readable medium of claim 28 wherein the method further comprises:
comparing the calculated distance between each corresponding multi-dimensional vector to a specified distance;
determining if the distance between two or more multi-dimensional vectors is within a specified distance;
determining that two or more multi-dimensional vectors having a distance between them that is within the specified distance constitute a cluster; and
designating a classification for this cluster.

47. The machine-readable medium of claim 46 wherein the method further comprises:
designating the classification of a cluster based upon the features of the two or more multi-dimensional vectors that constitute the cluster.

48. The machine-readable medium of claim 28 wherein the distance between each corresponding multi-dimensional vector of one or more portions of the plurality of corresponding multi-dimensional vectors is calculated using a specific distance metric.

49. The machine-readable medium of claim 48 wherein the specific distance metric is a cosine similarity distance metric.

50. The machine-readable medium of claim 48 wherein the specific distance metric is a ratio of weighted feature frequencies for the features the two multi-dimensional vectors have in common and weighted feature frequencies for the all features for the two multi-dimensional vectors.

51. The machine-readable medium of claim 48 wherein the specific distance metric is selected from the group of distance metrics consisting of a non-zero dimension proportionality distance metric, a Manhattan distance metric, a Euclidean distance metric, a cosine similarity distance metric, and combinations thereof.

52. The machine-readable medium of claim 46 wherein the specified distance is a distance range.

53. The machine-readable medium of claim 46 wherein the method further comprises:
specifying a second distance;
comparing the calculated distance between each corresponding multi-dimensional vector to the second distance;
determining if the distance between two or more multi-dimensional vectors is within the second distance;
determining that two or more multi-dimensional vectors having a distance between them that is within the second distance constitute an additional cluster; and
designating a classification to the additional cluster.

54. The machine-readable medium of claim 28 wherein the method further comprises, upon determination of a plurality of classifications:
specifying a second distance;
examining the classifications that result from the calculated distances, properties of the multi-dimensional vectors, and properties of the defined multi-dimensional vector space; and
determining one or more additional classifications for one or more respective portions of the electronic documents based upon the second distance and the classifications that result from the calculated distances, properties of the multi-dimensional vectors, and properties of the defined multi-dimensional vector space.

55. A system comprising:
a processor;
a network interface coupled to the processor; and
a machine-readable medium having stored thereon a set of instructions which when executed cause the system to perform a method comprising:
reducing each of a plurality of electronic documents to a corresponding multi-dimensional vector based upon the defined multi-dimensional vector space;
calculating a distance between each corresponding multi-dimensional vector of one or more portions of the plurality of corresponding multi-dimensional vectors, each portion of the plurality of corresponding multi-dimensional vectors containing a plurality of corresponding multi-dimensional vectors; and
determining one or more classifications for one or more respective portions of the electronic documents based upon the calculated distances, properties of the multi-dimensional vectors, and properties of the defined multi-dimensional vector space.

56. The system of claim 55 where the electronic documents have been initially assigned to one of a number of categories.

57. The system of claim 55 wherein the dimensions of the multi-dimensional vector space are defined by at least one feature.

58. The system of claim 57 wherein each of the at least one feature is selected based upon the differentiation ability of the feature.

59. The system of claim 57 wherein the at least one feature is based upon criteria selected from the group consisting of selected words, selected phrases, algorithms, phone numbers, and URLs.

60. The system of claim 59 where an algorithm returns a description of the structure and text of the electronic document.

61. The system of claim 60 where the algorithm extracts a pattern from the electronic document.

62. The system of claim 61 where the algorithm is a regular expression.

63. The system of claim 57 wherein each of the at least one feature is weighted based upon a differentiation ability of the feature.

64. The system of claim 63 wherein the feature weighting is based upon a rarity of occurrence in the multi-dimensional vector space.

65. The system of claim 63 wherein the feature weighting is based upon an occurrence in particular category and non-occurrence in at least one other category.

66. The system of claim 57 wherein the at least one feature is derived from a corpus of categorized electronic documents.

67. The system of claim 57 wherein the electronic document is reduced to a corresponding multi-dimensional vector based upon an occurrence and frequency of the at least one feature.

68. The system of claim 55 wherein the electronic document is an electronic communication.

69. The system of claim 68 wherein the electronic communication is an e-mail.

70. The system of claim 55 wherein the electronic document is an electronic publication.

71. The system of claim 70 wherein the electronic document is a world wide web page.

72. The system of claim 55 wherein the corresponding multi-dimensional vector indicates an occurrence and a frequency of one or more of the features in the defined vector space.

73. The system of claim 55 wherein the method further comprises:
comparing the calculated distance between each corresponding multi-dimensional vector to a specified distance;
determining if the distance between two or more multi-dimensional vectors is within a specified distance;
determining that two or more multi-dimensional vectors having a distance between them that is within the specified distance constitute a cluster; and
designating a classification for this cluster.

74. The system of claim 73 wherein the method further comprises:
designating the classification of a cluster based upon the features of the two or more multi-dimensional vectors that constitute the cluster.

75. The system of claim 55 wherein the distance between each corresponding multi-dimensional vector of one or more portions of the plurality of corresponding multi-dimensional vectors is calculated using a specific distance metric.

76. The system of claim 75 wherein the specific distance metric is a cosine similarity distance metric.

77. The system of claim 75 wherein the specific distance metric is a ratio of weighted feature frequencies for the features the two multi-dimensional vectors have in common and weighted feature frequencies for the all features for the two multi-dimensional vectors.

78. The system of claim 75 wherein the specific distance metric is selected from the group of distance metrics consisting of a non-zero dimension proportionality distance metric, a Manhattan distance metric, a Euclidean distance metric, a cosine similarity distance metric, and combinations thereof.

79. The system of claim 73 wherein the specified distance is a distance range.

80. The system of claim 73 wherein the method further comprises:
specifying a second distance;
comparing the calculated distance between each corresponding multi-dimensional vector to the second distance;
determining if the distance between two or more multi-dimensional vectors is within the second distance;
determining that two or more multi-dimensional vectors having a distance between them that is within the second distance constitute an additional cluster; and
designating a classification to the additional cluster.

81. The system of claim 55 wherein the method further comprises, upon determination of a plurality of classifications:
specifying a second distance;
examining the classifications that result from the calculated distances, properties of the multi-dimensional vectors, and properties of the defined multi-dimensional vector space; and
determining one or more additional classifications for one or more respective portions of the electronic documents based upon the second distance and the classifications that result from the calculated distances, properties of the multi-dimensional vectors, and properties of the defined multi-dimensional vector space.
